(19) United States
(12) Patent Application Publication
(10) Pub. No.: US 2003/0142335 A1
(43) Pub. Date: Jul. 31, 2003

(54) Conversion from page description language and conversion to printer language

(76) Inventors: John H. Oleinik, Camas, WA (US); Dan Revel, Portland, OR (US)

Correspondence Address: HEWLETT-PACKARD COMPANY, Intellectual Property Administration, P.O. Box 272400, Fort Collins, CO, 80527-2400, US

(21) Appl. No.: 10/062,976

(22) Filed: Jan. 30, 2002

(51) Int. Cl. G06F 15/00; B41B 1/00

(52) U.S. Cl. 358/1.13

(57) ABSTRACT

Conversion from a page description language (PDL) and conversion to a printer language is disclosed, as may be embodied in a device having two mechanisms. One mechanism is capable of converting a received file according to a printer-independent PDL to a first interim format. The other mechanism is capable of converting the received file, as has been converted to a second interim format, to a printer-specific printer language.

### BACKGROUND OF THE INVENTION

Printers have become popular peripherals for computer users. They allow users to print hardcopies of files onto a wide variety of different media. The files may include word processing files, copies of email messages, image files, as well as other types of files. The media most commonly is paper, but may also include other types of media.

For at least some types of printers, traditionally the computers to which they are communicatively connected translate the files to printer-specific printer languages that the printers can understand to correctly print the files. This is usually the case for inkjet printers in particular. When the user selects the print command from an application program running on a computer, for example, a previously installed printer driver converts the indicated file to a printer language, and sends it to the printer for printing.

More recently, devices other than computers have become popular with users. These devices include wireless phones, such as cellular (“cell”) phones, personal digital assistant (PDA) devices, as well as other types of mobile and other devices. As these devices have gained popularity, users have begun to utilize them in addition to or in lieu of traditional desktop and laptop computers for a variety of different functionality. For instance, limited Internet worldwide web (“web”) browsing, email retrieval and composition, and other tasks are increasingly being performed on such devices.

As a result, users may desire to print files from such devices on their printers. However, many such devices are unable to support printer drivers that can properly convert files on these devices to the printer-specific printer languages that many printers require. This can be for a number of different reasons. The manufacturers of the printers may not have developed printer drivers for the devices, for instance. More commonly, however, the resources needed to implement such printer drivers, in terms of memory, processing power, and so on, are beyond the capabilities of the devices. This means that users may not be able to print from these devices to their printers.

For these and other reasons, therefore, there is a need for the present invention.

### SUMMARY OF THE INVENTION

The invention may be embodied in a device having two mechanisms. One mechanism is capable of converting a received file according to a printer-independent page description language (PDL) to a first interim format. The other mechanism is capable of converting the received file, as has been converted to a second interim format, to a printer-specific printer language. Still other aspects and embodiments of the invention will become apparent by reading the detailed description of the invention, and by referring to the accompanying drawings.

### BRIEF DESCRIPTION OF THE DRAWINGS

FIG. 1 is a diagram of a system according to an embodiment of the invention, in which a client device generates a page description language (PDL) file that is converted to a printer language file by a converter device for sending to a printer for printing.

FIG. 2 is a diagram of the converter device of the system of FIG. 1 in more detail, according to an embodiment of the invention.

FIG. 3 is a diagram of the system of FIG. 1 in more detail, according to an embodiment of the invention, where the converter device of the system is in accordance with the embodiment of FIG. 2.

FIGS. 4 and 5 are diagrams of example embodiments of the converter device of FIG. 2, where the converter device has been upgraded to support additional PDL's and/or printer languages, via new PDL interpretation modules and/or printer language driver modules, respectively, according to different embodiments of the invention.

FIG. 6 is a flowchart of a method that outlines the functionality that can be supported by the converter device of FIG. 2, according to an embodiment of the invention.

### DETAILED DESCRIPTION OF THE INVENTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

Overview

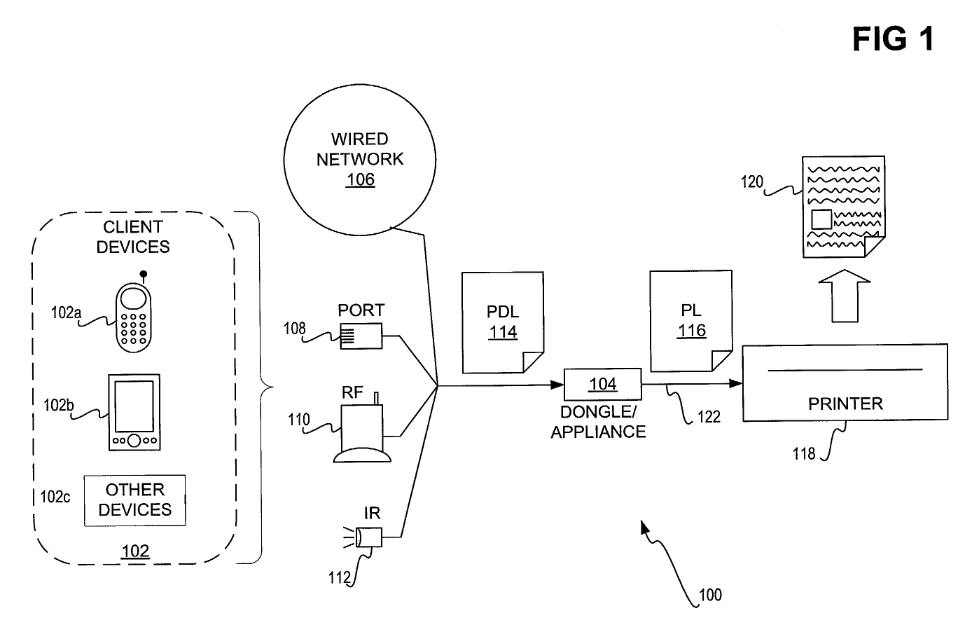

An overview of an embodiment of the invention is described with reference to FIG. 1, which shows a system 100 according to an embodiment of the invention. The system 100 includes client devices 102, a converter device 104, and a printer 118. The client devices 102 may be devices that cannot convert a file from a printer-independent page description language (PDL) to a printer-specific printer language by themselves. This may be because the devices 102 do not have the necessary resources, such as memory, processing power, and so on, to perform the conversion. The devices 102 can include cell phones 102a, personal digital assistant (PDA) devices 102b, as well as other types of mobile and other devices 102c. However, the client devices 102 may also include standard desktop and laptop computers, as well as other devices, that do have the necessary resources to convert files from a PDL to a printer language themselves, or do not contain or have access to printer language conversion software or technology.

The client devices 102 are communicatively coupled with the converter device 104. Four specific types of communicative coupling are shown in FIG. 1, although these are for example only, and do not represent limitations of the invention itself. For instance, a wired network 106, such as one or more of an Ethernet network, an intranet, an extranet, the Internet, a local-area network (LAN), and a wide-area network (WAN), may communicatively couple the devices 102 to the device 104. The client devices 102 may directly plug into a port 108 of the device 104, such as a serial bus like the Universal Serial Bus (USB). The client devices 102 may communicatively couple to the device 104 in a wireless manner, such as via a radio frequency (RF) device 110, or an infrared (IR) device 112. The RF device 110 may be compatible with known RF standards, such as 802.11a , 802.11b , Wi-Fi, Bluetooth, and so on.

The client devices 102 generate a PDL file 114. The term file is used generally and non-restrictively herein, and encompasses any type of image, document, or other item that users of the client devices 102 desire to print on the printer 118. The file 114 is in accordance with a printer-independent PDL. Such PDL's may include PostScript, Portable Document Format (PDF), mark-up languages such as eXtensible Mark-up Language (XML) and HyperText Mark-up Language (HTML), application formats such as Microsoft Word and Microsoft PowerPoint, and so on. A PDL is more generally and non-restrictively a printer-independent, device-independent manner for describing a file that can be printed. That is, a PDL is not specific to a type or brand of printer, and therefore a file 114 in accordance with a PDL must be converted before it can be printed on the printer 118.

The converter device 104 thus receives the PDL 114 from the devices 102. The converter device 104 may be a dongle directly or indirectly attached to the printer 118, as indicated by the line 122. Alternatively, the device 104 may be an appliance that directly or indirectly attaches to the printer 118, as also indicated by the line 122. For instance, the device 104 may be on the same network as the printer 118, receiving the PDL file 114 intended for printing on the printer 118. The term appliance is meant to convey a device that is dedicated to a specific function, in this case conversion, as opposed to a general-purpose computer. The term dongle is meant to convey a smaller form factor device that has a port that directly plugs into a port of the printer 118, or connects indirectly via a cable.

The converter device 104 converts the PDL file 114 to a printer-specific printer language file 116. A printer language is generally a format that a specific, corresponding printer directly understands, such that it can print a file provided to it in the printer language. An example of a printer language is the Printer Control Language (PCL) used by printers manufactured by and available from HewlettPackard Company, of Palo Alto, Calif. A printer language, therefore, is specific to one or more different types of printers. Printers from one manufacturer, for instance, may not be able to understand printer languages that printers from another manufacturer can understand. A printer model from a given manufacturer may also not understand printer languages from another, different printer model from the same manufacturer. Unlike a PDL a printer language is thus printer-specific. Because the converter device 104 converting the PDL file 114 to the printer language file 116, the client devices 102 do not have to perform this finctionality themselves, such that they may not have to have printer-specific printer drivers installed therein for performing such fuictionality.

The converter device 104 sends the printer-specific printer language file 116 to the printer 118, to which the printer language in accordance with which the file 116 has been converted corresponds. The printer 118 then generates a hardcopy 120 corresponding to the file 116, which itself corresponds to the file 114 received from the client devices 102. The hardcopy is typically printed on paper, but may be printed on other types of media as well. In this way, the converter device 104 enables the client devices 102 to print on the printer 118, without having to have the client devices 102 themselves convert the PDL file 114 to the printer language file 116 that the printer 118 understands and needs to generate the hardcopy 120.

Converter Device

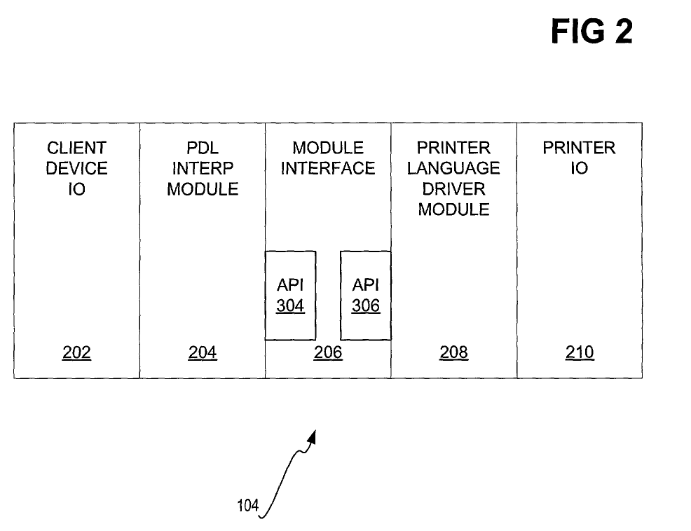

FIG. 2 shows an embodiment of the converter device 104 of FIG. 1 in more detail. The converter device 104 includes client device input/output (IO) 202, a printer-independent PDL interpretation module 204, a module interface 206, a printer-specific printer language driver module 208, and printer IO 210. The client device IO 202 is hardware and software that enables the converter device 104 to receive a PDL file from a client device. The hardware may be specific to one or more types of communicative coupling between the converter device 104 and a client device, such as wired and wireless network connectivity, direct connection capability, and infrared connectivity, as have been mentioned. Similarly, the printer IO 210 is hardware and software that enables the converter device 104 to send a printer language file to a printer. The hardware may be specific to one or more types of coupling between the converter device 104 and the printer, such as network connectivity, and direct connection capability.

The PDL interpretation module 204 may be hardware, software, or both hardware and software. The term module is meant to convey that it can be a distinct component of the converter device 104. Another, more general term for module is mechanism. The PDL interpretation module 204 preferably converts a PDL file received through the client device IO 202 to a first interim format specified by an application programming interface (API) 304 of the module interface 206. That is, the PDL interpretation module 204 converts the PDL file not to a specific printer language, but rather to a first intermediate meta format, or interim format, specified by the module interface 206. In this way, the PDL interpretation module 204 is independent of the printer language driver module 208, and thus is upgradeable independently of the printer language driver module 208, as will be described.

The module interface 206 may also be hardware, software, or both hardware and software. The module interface 206 preferably and specifically provides two API's 304 and 306, one describing the first interim format to which the PDL interpretation module 204 converts received PDL files, and another describing the second interim format from which the printer language driver module 208 converts printer-specific printer language files for sending to a printer. Thus, each of the PDL interpretation module 204 and the printer language driver module 208 is programmed only to its respective API of the interface module 206, and not to one another. This abstraction or independence from one another enables the modules 204 and 208 to be separately upgraded with regard to the other.

The module interface 206 therefore preferably converts a file from the first interim format to the second interim format. However, alternatively, the first and the second interim formats are identical, such that the module interface 206 does not have to perform any conversion. Furthermore, the module interface 206 may support a number of different first interim formats, as well as a number of different second interim formats. In such a case, the API 304 may actually encompass a number of different API's corresponding to the different first interim formats, and the API 306 may actually encompass a number of different API's corresponding to the different second interim formats.

The interim formats to which the PDL interpretation module 204 converts received PDL files, and from which the printer language printer driver 208 converts interim format files to printer-specific printer language files, may be different from one another in one embodiment for the following reason. Some PDL's are more easily and/or more popularly converted to various interim formats. Similarly, some printer-specific printer languages are more easily and/or more popularly converted from other various interim formats. Therefore, in the embodiment of the invention where the first interim format to which the PDL interpretation module 204 converts received PDL files is different than the second interim format from which the printer language printer driver 208 converts printer-specific printer languages, the module interface 206 performs first interim format-to-second interim format conversions. This may ensure that PDL interpretation modules and printer language printer drive modules are more easily developed to support additional PDL's and printer-specific printer languages, respectively.

The printer language driver module 208 preferably converts a file in accordance with the second interim format specified by the API 306 of the module interface 206. Thus, the PDL interpretation module 204 converts a received file from PDL to a first interim format and the module interface 206 converts the file from the first interim format to the second interim format. The printer language driver module 208 then converts the file from the second interim format to a printer-specific printer language suitable for sending to a printer for printing. The printer language driver module 208 is referred to as a driver in that it incorporates elements traditionally considered as part of printer driver functionality. The module 208 is able to convert a second interim format file to a printer language file that is suitable for sending to one or more different types of printers, but likely not all types of printers, that understand its printer language. Because the printer language driver module 208 converts a file from the second interim format specified by the module interface 206, and not from a specific PDL, the module 208 is independent of the PDL interpretation module 204, and thus is upgradeable independently of the module 204, as will be described.

Once the printer language driver module 208 has converted a second interim format file to a printer-specific printer language file, the file is sent to a printer connected to the converter device 104 through the printer IO 210. The printer, since it understands the printer language in accordance with which the file is now formatted, can then print the file as hardcopy on media. Thus, the converter device 104 converts a PDL file to an intermit format file to a printer-specific printer language file, via its PDL interpretation module 204 and printer language driver module 208 that each interface with an API of the module interface 206. This conversion therefore does not have to be performed by a client device itself, but rather is offloaded to the converter device 104.

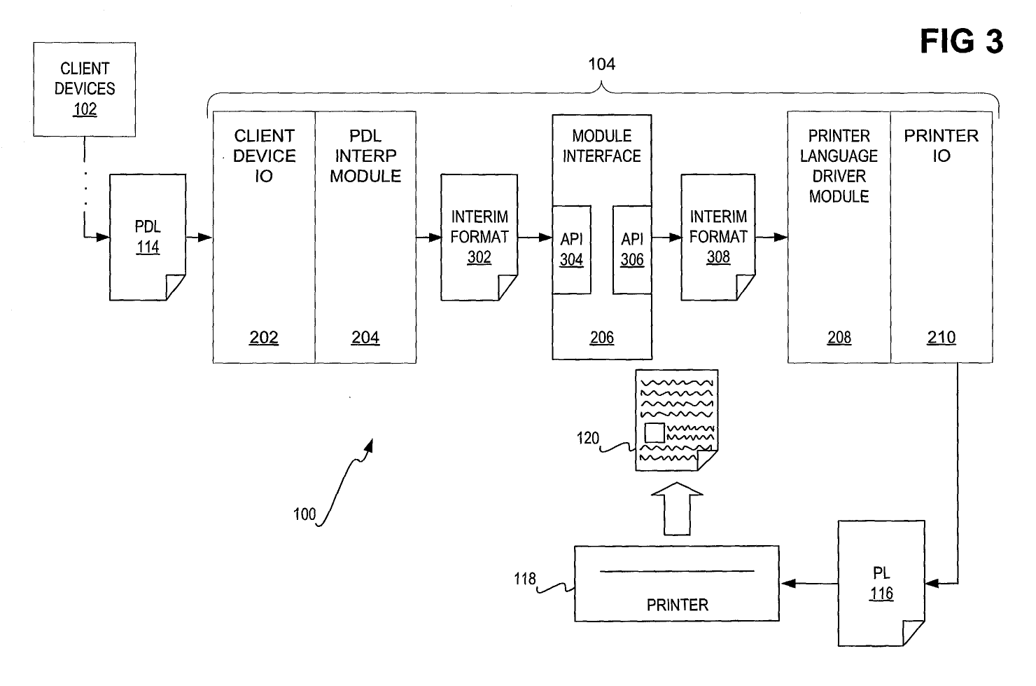

FIG. 3 shows the system 100 in more detail, incorporating the implementation of the converter device 104 as has been described with reference to and shown in FIG. 2. One of the client devices 102 generates a PDL file 114 that is desired to be printed on the printer 118. The PDL interpretation module 204 receives the PDL file 114 through the client device I0 202, and generates a first interim format file 302, converting the PDL file 114 thereto, in accordance with an API 304 of the module interface 206. The module interface 206 converts the first interim format file 302 to a second interim format file 308, such that the printer language driver module 208 receives the second interim format file 308 in accordance with an API 306 of the module interface 206. However, where the first interim format is identical to the second interim format, the module interface 206 does not perform any conversion, and the file 302 is identical to the file 308. The printer language driver module 208 then converts the second interim format file 308 to a printer-specific printer language file 116. The printer language file 116 is sent through the printer IO 210 to the printer 118, which is then able to generate a hardcopy 120 representing the PDL file 114, as converted to the interim format file 302 and then to the printer language file 116.

Independent Upgradeability of PDL Interpretation and Printer Language Driver Modules

As has been indicated, the PDL interpretation module 204 and the printer language driver module 208 are independently upgradeable. This is because each is programmed to the same or different interim formats specified by API's of the module interface 206. Independent upgradeability in the case of the PDL interpretation module 204 means that the converter device 104 can be upgraded to support additional PDL's, without concern for the printer languages that the printer language driver module 208 supports. Similarly, independent upgradeability in the case of the printer language driver module 208 means that the converter device 104 can be upgraded to support additional printer languages, and hence additional printers, without concern for the PDL's that the PDL interpretation module 204 supports.

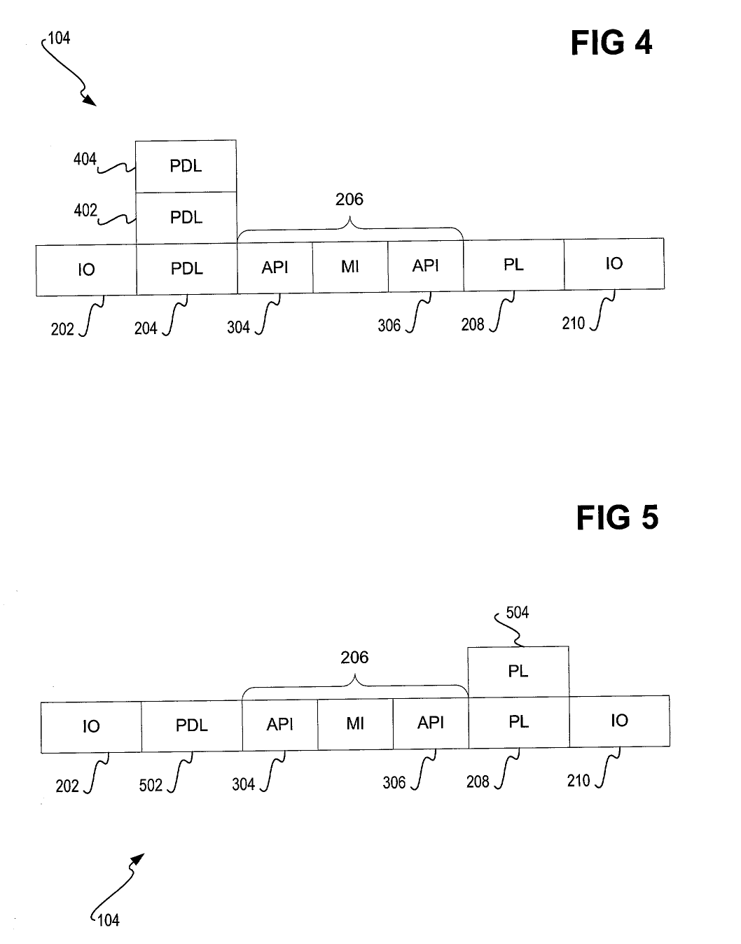

FIG. 4 shows an example embodiment of the converter device 104, where the PDL interpretation module 208 has been upgraded to support additional PDL's. Specifically, the PDL upgrade modules 402 and 404 have been added to the PDL interpretation module 208, so that two new PDL's, in addition to the PDL initially supported by the module 208, are supported by the converter device 104. Thus, a PDL file received through the IO 202 is converted by the corresponding module 204, 402, or 404 to the first interim format specified by the API 304 of the module interface 206. The printer language driver module 208 as before receives the second interim format file as specified by the API 306 of the interface 206. The module 208 converts the second interim format file to a printer-specific printer language file, which is then sent to a printer for printing through the IO 210. The addition of the PDL interpretation modules 402 and 404 does not depend on the printer languages supported by the driver module 208, since the modules 402 and 404 are programmed to conform to the API 304 of the interface 206.

FIG. 5 shows another example embodiment of the converter device 104. The PDL interpretation module 204 of the converter device 104 has been replaced by the PDL interpretation module 502, and the printer language driver module 208 has been upgraded to support an additional printer language through the addition of a printer language upgrade module 504. Therefore, a PDL file received through the IO 202 must now be in accordance with a PDL specified by the PDL interpretation module 502. The module 502 converts the PDL file to the first interim format specified by the API 304 of the module interface 206. The PDL interpretation module 502 does not depend on the printer languages supported by the driver modules 208 and 504, since the module 502 is programmed to conform to the API 304 of the interface 206.

Depending on the printer to which the IO 210 is connected, one of the printer language driver modules 208 and 504 receives the second interim format file as specified by the API 306 of the interface 206, and converts this file to a printer language file. The printer language file is then sent to the printer for printing through the IO 210. The presence of two printer language driver modules 208 and 504 means that the converter device 104 of FIG. 5 can be connected to at least two different types of printers, those understanding the printer languages supported by the module 208, and those understanding the printer languages supported by the module 504. The driver modules 208 and 504 do not depend on the PDL's supported by the PDL interpretation module 502, since the modules 208 and 504 are programmed to conform to the API 306 of the interface 206.

The addition to or replacement of the PDL interpretation module 204 and the printer language driver module 208 of the converter device 104 can be accomplished in a number of different ways not limited by the invention itself. For instance, a computer-readable medium, such as an optical storage medium or a solid-state semiconductor storage medium, may be placed in a corresponding removable storage device of the device 104. The medium has instructions to support additional PDL's and/or printer languages. In this way, the device 104 is directly upgradeable to support additional printer-independent PDL's and/or printer-specific printer languages.

As another example, a computer-readable medium may have instructions to support additional PDL's and/or printer languages that are transferred to a host computer to which the device 104 is communicatively coupled, via a direct connection, a network connection, and so on. The host computer may receive the instructions stored on the computer-readable medium by the medium being placed in the host computer, or by the host computer retrieving the instructions from over a network, such as the Internet. The host computer then uses the instructions to correspondingly upgrade the device 104. In this way, the device 104 is indirectly upgradeable to support additional printer-independent PDL's and/or printer-specific printer languages.

Method

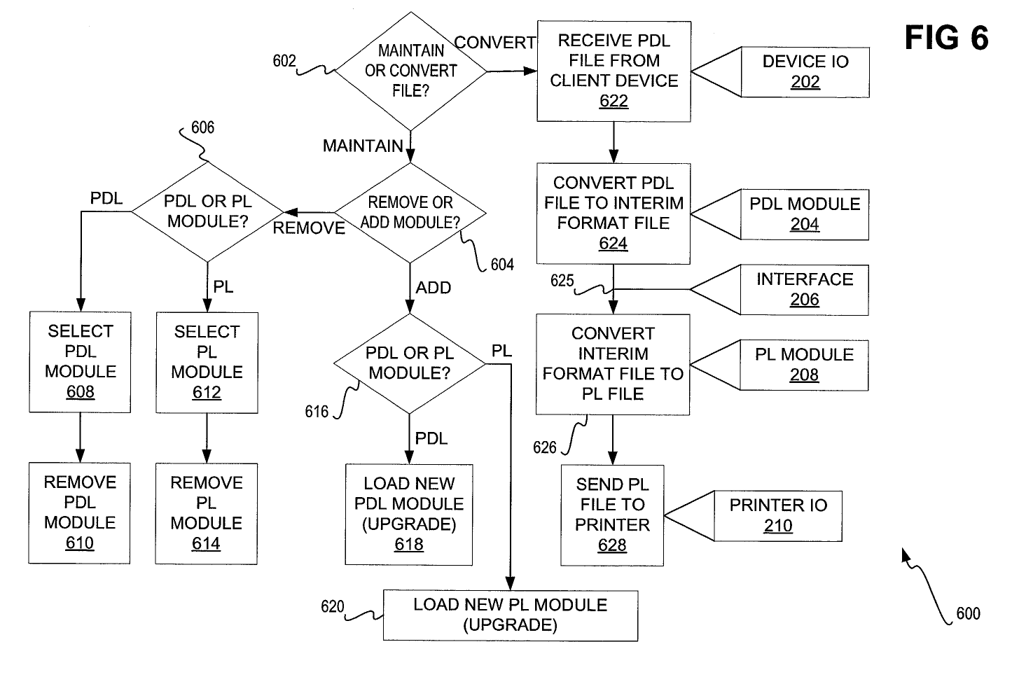

FIG. 6 shows a method 600 according to an embodiment of the invention that outlines the functionality that can be performed by and in relation to the converter device 104 that has been described. Two types of functionality are outlined in the method 600, device maintenance functionality and file conversion functionality (602). With respect to device maintenance functionality, modules can be removed from the converter device 104 or added to the device 104 (604). The method 600 specifically describes the scenario where the interim format to which PDL interpretation modules convert PDL files is identical to the interim format from which printer language driver modules convert interim format files to printer language files.

When removing an existing module, the existing module may be a PDL interpretation module or a printer language driver module (606). In the former case, an existing PDL module is selected for removal (608), and then is removed from the device 104 (610). This may encompass deleting support for one or more PDL's from non-volatile memory or other storage of the converter device 104. Similarly, in the case of a printer language driver module, an existing printer language driver module is selected for removal (612), and then is removed from the device 104 (614). This may also encompass deleting support for one or more printer languages from non-volatile memory or other storage of the converter device 104.

When adding a module, either a PDL interpretation module or a printer language driver module may be added (616). In the former case, the new PDL interpretation module is loaded onto the converter device 104 (618). Thus, the device 104 has been upgraded to support one or more additional PDL's. In the latter case, the new printer language driver module is loaded onto the converter device 104 (620). The device 104 has thus been upgraded to support one or more additional printer languages.

For PDL file conversion, first a printer-independent PDL file is received from a client device (622). This is performed by the device IO 202 of the converter device 104, as is shown in FIG. 6. The PDL file is converted to an interim format file (624). This is performed by the PDL module 204 of the converter device 104, as is shown in FIG. 6. The interim format file is then converted to a printer-specific printer language file (626). This is performed by the printer language driver module 208 of the converter device 104, as is shown in FIG. 6.

The arrow 625 leading from 624 to 626 specifically represents the separation of the PDL file-to-interim format file conversion process from the interim format-to-printer language file conversion process. This separation is accomplished by the module interface 206 of the converter device 104, as is shown in FIG. 6, by the module interface 206 having an API to which the PDL interpretation module 204 is programmed, and an API to which the printer language driver module 208 is programmed. Furthermore, in the case where the interim format to which the PDL files are converted is different than the interim format from which the interim format files are converted to printer-specific printer language files, the module interface 206 further performs a conversion from the first interim format to the second interim format. Finally, the printer language file is sent to a printer connected to the converter device 104, for printing (628). This is performed by the printer IO of the converter device 104, as is shown in FIG. 6.

Conclusion

It is noted that, although specific embodiments have been illustrated and described herein, it will be appreciated by those of ordinary skill in the art that any arrangement that is calculated to achieve the same purpose may be substituted for the specific embodiments shown. Other applications and uses of embodiments of the invention, besides those described herein, are amenable to at least some embodiments. This application is intended to cover any adaptations or variations of the present invention. Therefore, it is manifestly intended that this invention be limited only by the claims and equivalents thereof.

What is claimed is:

1. A device comprising:
a first mechanism capable of converting a received file according to a printer-independent page description language (PDL) into a first interim format; and,
a second mechanism capable of converting the received file as converted to a second interim format into a printer-specific printer language.

2. The device of claim 1, wherein the first interim format is identical to the second interim format.

3. The device of claim 1, further comprising an interface capable of converting the received file from the first interim format to the second interim format, the first interim format different than the second interim format.

4. The device of claim 1, further comprising a client input/output (I/O) mechanism to communicatively couple with one or more clients, and capable of receiving the received file from one of the one or more clients.

5. The device of claim 4, wherein the client I/O mechanism is able to communicatively couple with the one or more clients via one or more of: a network connection, a serial bus connection, a wireless infrared (IR) connection, and a wireless radio-frequency (RF) connection.

6. The device of claim 1, further comprising a printer input/output (I/O) mechanism to communicatively couple with a printer capable of understanding the received file as converted to the printer-specific printer language.

7. The device of claim 6, wherein the printer I/O mechanism has a port corresponding to a port of the printer, such that the device directly connects to the printer via the port of the printer I/O mechanism plugging into the port of the printer.

8. The device of claim 1, wherein each of the first mechanism and the second mechanism is independently upgradeable with respect to one another, the first mechanism independently upgradeable to support one or more additional printer-independent PDL's, and the second mechanism independently upgradeable to support one or more additional printer-specific printer languages.

9. A device comprising:
an independently upgradeable printer-independent page description language (PDL) interpretation module;
an independently upgradeable printer-specific printer language creation driver module; and,
a module interface interfacing the printer-independent PDL interpretation module to the printer-specific printer language creation driver module.

10. The device of claim 9, wherein the printer-independent PDL interpretation module converts a file from a corresponding printer-independent PDL to a first interim format, the module interface converts the file from the first interim format to a second interim format, and the printer-specific printer language creation driver module converts the file from the second interim format to a corresponding printer-specific printer language.

11. The device of claim 9, further comprising:
a client input/output (I/O) communication interface coupled to the printer-independent PDL interpretation module and communicatively coupled to one or more clients; and,
a printer I/O communication interface coupled to the printer-specific printer language creation driver module and communicatively coupled to a printer.

12. The device of claim 9, wherein the printer-independent PDL interpretation module comprises one or more printer-independent PDL interpreters corresponding to different PDL's.

13. The device of claim 12, wherein the printer-independent PDL interpretation module is upgradeable to add one or more additional printer-independent PDL interpreters corresponding to additional PDL's.

14. The device of claim 9, wherein the printer-specific printer language creation driver module comprises one or more printer-specific printer language creation drivers corresponding to different printers.

15. The device of claim 14, wherein the printer-specific printer language creation driver is upgradeable to add one or more additional printer-specific printer language creation drivers corresponding to additional printers.

16. A device comprising:
first means for converting a received file according to a printer-independent page description language (PDL) to a first interim format;
second means for converting the received file as converted to a second interim format to a printer-specific printer language; and,
third means for interfacing the first means with the second means.

17. The device of claim 16, wherein the first interim format is identical to the second interim format.

18. The device of claim 16, wherein the first interim format is different than the second interim format, the third means converting the received file from the first interim format to the second interim format.

19. The device of claim 16, further comprising means for communicating with one or more clients to initially receive the received file.

20. The device of claim 16, further comprising means for connecting to one or more printers to send the received file as converted from the interim format to the printer-specific printer language for printing.

21. A method comprising:
receiving a file according to a printer-independent page description language (PDL);
converting the file from the printer-independent PDL to a first interim format;
converting the file from a second interim format to a printer-specific printer language; and,
sending the file as converted to the printer-specific printer language to a printer for printing.

22. The method of claim 21, further comprising, after converting the file from the PDL to the first interim format, and prior to converting the file from the second interim format to the printer-specific language, converting the file from the first interim format to the second interim format, the first interim format being different than the second interim format.

23. The method of claim 21, wherein the first interim format is identical to the second interim format.

24. The method of claim 21, further comprising upgrading to support a second printer-independent PDL.

25. The method of claim 24, further comprising:
receiving a second file according to the second printer-independent PDL;
converting the second file from the second printer-independent PDL to a third interim format;
converting the second file internally from the third interim format to the printer-specific printer language; and,
sending the second file as converted to the printer-specific printer language by the device to the printer for printing.

26. The method of claim 21, further comprising upgrading to support a second printer-specific printer language.

27. The method of claim 26, further comprising:
receiving a second file according to the printer-independent PDL;
converting the second file from the printer-independent PDL to a third interim format;
converting the second file from the third interim format to a fourth interim format;
converting the second file from the fourth interim format to the second printer-specific printer language; and,
sending the second file as converted to the second printer-specific printer language to a second printer for printing.

28. A computer-readable medium having instructions stored thereon to upgrade a device for converting a file according to a printer-independent page description language (PDL) received from a client to a first interim format and for converting the file as converted to a second interim format to a printer-specific printer language for sending to a printer for printing so that the device is able to convert additional files according to one or more additional printer-independent PDL's to the first interim format.

29. The medium of claim 28, wherein the medium is insertable into the device to upgrade the device to support the one or more additional printer-independent PDL's.

30. The medium of claim 28, wherein the instructions are transferable to a host device communicatively coupled to the device, such that the host device executes the instructions to upgrade the device to support the one or more additional printer-independent PDL'S.

31. A computer-readable medium having instructions stored thereon to upgrade a device for converting a file according to a printer-independent page description language (PDL) received from a client to a first interim format and for converting the file as converted to a second interim format to a printer-specific printer language for sending to a printer for printing so that the device is able to convert additional files as converted to the second interim format to one or more additional printer-specific printer languages corresponding and for sending to additional printers.

32. The medium of claim 31, wherein the medium is insertable into the device to upgrade the device to support the one or more additional printer-specific printer languages.

33. The medium of claim 31, wherein the instructions are transferable to a host device communicatively coupled to the device, such that the host device executes the instructions to upgrade the device to support the one or more additional printer-specific printer languages.

34. A computer-readable medium having instructions stored thereon for a computer program comprising:
first means for converting a received file according to a printer-independent page description language (PDL) to a first interim format;
second means for converting the received file as converted to a second interim format to a printer-specific printer language; and,
third means for interfacing the first means with the second means.

35. The medium of claim 34, wherein the first interim format is identical to the second interim format.

36. The medium of claim 34, wherein the first interim format is different than the second interim format, the third means converting the received file from the first interim format to the second interim format.
